(19) United States
(12) Patent Application Publication
(10) Pub. No.: US 2020/0104689 A1
(43) Pub. Date: Apr. 2, 2020

(54) SYNERGISTIC EFFECTOR/ENVIRONMENT DECODING SYSTEM

(71) Applicant: Brown University, Providence, RI (US)

(72) Inventors: John DONOGHUE, Providence, RI (US); Carlos VARGAS-IRWIN, Providence, RI (US)

(21) Appl. No.: 16/589,615

(22) Filed: Oct. 1, 2019

Related U.S. Application Data
(60) Provisional application No. 62/739,734, filed on Oct. 1, 2018.
(60) Provisional application No. 62/857,015, filed on Jun. 4, 2019.

(51) Int. Cl. G06N 3/06; G06N 3/063; G06N 3/067; G06N 20/00; B25J 9/16

(52) U.S. Cl. CPC G06N 3/061; G06N 3/063; B25J 9/163; G06N 20/00; G06N 3/067

(57) ABSTRACT

A system includes a neural recording device implanted in a brain, a neural processing unit configured to receive raw neural data from the neural recording device, an external sensor, an artificial sensing processing unit configured to receive raw sensor data from the external sensor, and a decoder configured to receive and combine a mixed sensory-motor representation from the neural processing unit and surrogate sensory input from the artificial sensing processing unit.

### CROSS REFERENCE TO RELATED APPLICATIONS

This application claims benefit from U.S. Provisional Patent Application Ser. No. 62/739734, filed Oct. 1, 2018, and U.S. Provisional Patent Application Ser. No. 62/857015, filed Jun. 4, 2019, which are incorporated by reference in their entireties.

### STATEMENT REGARDING GOVERNMENT INTEREST

This invention was made with government support under New Innovator Award DP2 NS111817 from the National Institutes of Health (NINDS). The government has certain rights in the invention.

### BACKGROUND OF THE INVENTION

The present invention relates generally to brain-computer interfaces, and more particularly to a synergistic effector/environment decoding system.

In general, brain-computer interfaces (BCI) are systems that provide communications between human beings and machines. BCI's can be used, for example, by individuals to control an external device such as a wheelchair. It is also possible to use BCIs to activate functional electrical stimulation systems that can artificially trigger muscle contraction, restoring movement to paralyzed limbs. A major goal of BCI is to decode intent from the brain activity of an individual, and signals representing the decoded intent are then used in various ways to communicate with an external device. BCI's hold particular promise for aiding people with severe motor impairments.

BCI systems can be used to bypass damaged neural pathways, allowing people with movement or other neurological disorders to directly control assistive devices with their thoughts, i.e., the neural activity patterns associated with volitional intent recorded using specialized sensors. Current BCI systems for movement restoration are designed to extract information related to intended movements from neural activity, ignoring information reflecting sensory signals. However, sensory and motor information are tightly intertwined in cortical circuits due to the massive projections from sensory to motor areas, making it difficult to isolate signals encoding motor intention from other signals that often are aggregately considered to be noise. Even the best examples of BCI control to date result in very slow movements that lack the accuracy of normal human actions.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a system including a neural recording device implanted in a brain, a neural processing unit configured to receive raw neural data from the neural recording device, an external sensor, an artificial sensing processing unit configured to receive raw sensor data from the external sensor, and a decoder configured to receive and combine a mixed sensory-motor representation from the neural processing unit and surrogate sensory input from the artificial sensing processing unit.

In another aspect, the invention features a system including a neural sensor adapted to be implanted beneath a scalp of a subject and configured to provide neural signals of the subject, a camera system adapted to provide external sensor data from an environment of the subject, an acquisition computer coupled to the neural sensor and the camera system for collecting and storing the neural signals and the external sensor data, and coupled to the acquisition computer, a computer having software configured to process the neural signals and external sensor data.

In still another aspect, the invention features a method including implanting microelectrode arrays into a cortical surface, recording a neural data stream from the microelectrode arrays, receiving a stream of external sensor readings, sending the streams of recorded neural data and external sensor readings to a decoder, processing a combined stream of the recorded neural data stream and external sensor readings stream in the decoder, and generating a command signal to an external effector from the processed combined stream.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an illustration of an exemplary system.

FIG. 2 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

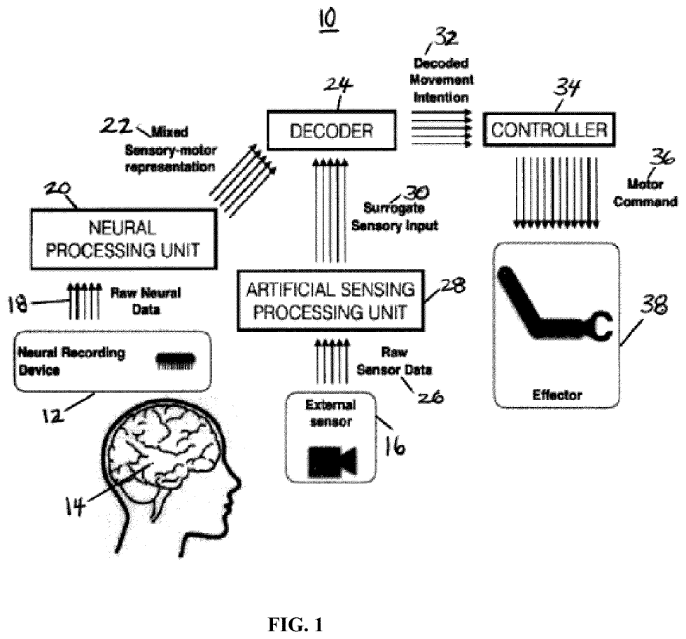

As shown in FIG. 1, an exemplary system 10 includes a neural recording device 12 (e.g., microelectrode array) capable of detecting activity of the nervous system 14. The neural recording device 12 sends raw neural data 18 to a neural processing unit 20. The neural processing unit 20 sends mixed sensory-motor representations 22 to a decoder 24.

More specifically, the neural processing unit 20 extracts relevant features from the raw neural data 18. These features may include single unit firing rates, local field potentials or related signals. These features may be combined using techniques such as dimensionality reduction or other supervised feature extraction methods in order to generate efficient representations of sensory-motor processing, which will reflect a combination of sensory information and volitional movement intention present in neural activity patterns.

The system 10 also includes an external sensor 16 that sends raw sensor data 26 to an artificial sensing processing unit 28. The artificial sensing processing unit 28 sends surrogate sensory input 30 to the decoder 24 where it is combined with the mixed sensory-motor representation 22 to generate a decoded movement intention 32, which is sent to a controller 34. The controller 36 sends a motor command 36 to an effector 38.

More specifically, the artificial sensing processing unit 28 takes the raw sensor data 26 from the external sensor 16 (e.g., a video camera) and extracts relevant information to create a representation of the external environment. For example, machine vision can be used to estimate a position, size, and shape of objects in the surrounding environment. In embodiments, sensory data may be reconstructed more accurately by using additional sensors to detect data related to sensory percepts (e.g., tracking eye movements with an additional camera, proprioceptive inputs using haptic sensors, and so forth).

The decoder 24 is designed to estimate movement intention based on the mixed sensory motor representations 22 derived from the raw neural data 18 and the surrogate sensory input 30. Having access to surrogate sensory input 30 allows the decoder 24 to interpret neural activity in a context-dependent manner. This strategy also allows the decoder 24 to ‘de-noise’ movement intention by eliminating sensory components of the raw neural data 18.

The controller 34 takes the decoded movement intention 32 and translates it into an effector-specific command 36 to carry out a desired action. This mapping from movement intention 32 to motor commands 36 can be biometric (e.g., using an intended arm movement to move a robotic arm, or a paralyzed human arm driven by functional electrical stimulation) or arbitrarily assigned to a desired function on any controllable device (e.g., moving a wheelchair forward).

The raw sensor data 26 from the external sensor 16 has information about all possible goals in the environment, distance to that goal, shape of objects, obstacles in the way, but not which goal or how person wants to interact with it (e.g., pick up, knock over, and so forth). The brain 14 has noisy information about a specific object of interest, direction to reach, type of grasp needed for that object and when it should be grasped, moved, lifted, manipulated, and so forth (e.g., TIME and type of action).

Combining patterns using machine learning and state space dynamics results in computationally efficient ways of dealing with large amounts of information. In one specific embodiment, machine learning reduces a visual pattern based on neural activity, i.e., once a target is known very little information about other parts of a scene.

The system 10 includes a decoding strategy that uses raw sensor data 26 gathered from the environment using the external sensor 16 (e.g., video camera 14) in order interpret volitional neural activity more accurately. The system 10 uses external sensor readings to model the sensory components of the neural response, allowing one to produce ‘de-noised’ motor control signals. Neural activity in motor cortical areas reflects sensory-motor transformations. The system 10 explicitly incorporates a sensory component, greatly enhancing an ability to correctly interpret motor intention, compensating for context-dependent changes in neural encoding that dynamically reshape evolving neural activity patterns in motor cortical areas. The system 10 gives the decoder 24 the ability to adjust motor commands 36 based on sensory inputs 30. For example, the external sensor 16 can provide information about the size and position of objects present in the environment, while neural activity might reflect similar information combined with signals reflecting the volitional intent to interact with a given object. The decoder 24 combines these information streams to, for example, accurately guide the effector 38 (e.g., a robot arm) to grasp a desired object.

The system 10 uses raw neural data 18 and raw sensor data 26 in a way that is fundamentally different from previous techniques. In previous work, each data stream (biological or artificial signals) is used to calculate motor commands independently, without knowledge of the other. Control then switches between these two outputs or is calculated as a weighted sum. By contrast, the system 10 focuses on actively combining signals derived from raw neural data 18 and raw sensor data 26 before motor commands 36 are generated. Instead of using external sensors to trigger automated responses, the system 10 uses information captured from the environment to interpret the observed pattern of neural activity more accurately. In this way, the system 10 always keeps the intention of the human user in the control loop, in contrast to previous shared control paradigms where the end stages may be completely automated. A wide range of inexpensive, easily available sensors can be incorporated into the decoder 24, including video cameras, depth sensors, haptic sensors, and others.

The decoder 24 can be used to develop more effective brain-computer interface devices aiming to restore dexterous movement control to people with motor disorders. Supplementing or potentially replacing cortical signals with data derived from external sensors can also reduce the need to record neural data from multiple sites in the nervous system, minimizing surgical interventions.

In system 10, signals previously interpreted as “noise” in motor cortex actually represent information from the surrounding environment (e.g., the visual scene). The decoder 24 actively captures this information using the external sensor 16 (e.g., camera). Combining data from the brain with data from external sensors enables the decoder 24 (e.g., a neural network) to remove non-motor components and extract a “clean” signal related to intended movements.

The decoder 24 can be used to develop more effective brain-computer interface devices aiming to restore dexterous movement control to people with motor disorders. Supplementing or potentially replacing cortical signals with data derived from external sensors can also reduce the need to record neural data from multiple sites in the nervous system, minimizing surgical interventions.

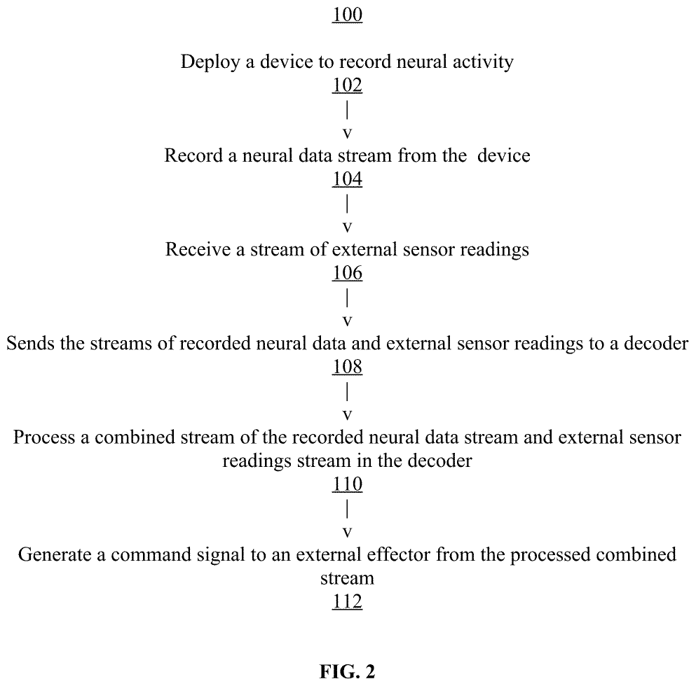

As shown in FIG. 2, a process 100 includes deploying (102) a device to record neural activity (e.g.,implanting (102) microelectrode arrays into a cortical surface).

Process 100 records (104) a neural data stream from the device.

Process 100 receives (106) a stream of external sensor readings.

Process 100 sends (108) the streams of recorded neural data and external sensor readings to a decoder and processes (110) a combined stream of the recorded neural data stream and external sensor readings stream in the decoder.

Process 100 generates (112) a command signal to an external effector from the processed combined stream.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A system comprising:
a neural recording device implanted in a brain;
a neural processing unit configured to receive raw neural data from the neural recording device;
an external sensor;
an artificial sensing processing unit configured to receive raw sensor data from the external sensor; and
a decoder configured to receive and combine a mixed sensory-motor representation from the neural processing unit and surrogate sensory input from the artificial sensing processing unit.

2. The system of claim 1 further comprising a controller configured to receive a decoded movement intention from the decoder and generate a motor command.

3. The system of claim 2 further comprising an effector configured to receive and execute the motor command.

4. The system of claim 3 wherein the effector is selected from the group consisting of a human arm body part, a robot, and computer.

5. A system comprising:
a neural sensor adapted to be implanted beneath a scalp of a subject and configured to provide neural signals of the subject;
a camera system adapted to provide external sensor data from an environment of the subject;
an acquisition computer coupled to the neural sensor and the camera system for collecting and storing the neural signals and the external sensor data; and
coupled to the acquisition computer, a computer having software configured to process the neural signals and external sensor data.

6. The system of claim 5 wherein the acquisition computer comprises a decoder.

7. The system of claim 6 wherein processing the neural signals and external sensor data in combination generates a command signal.

8. The system of claim 7 further comprising an effector.

9. The system of claim 8 wherein the command signal causes the effector to perform an action with respect to an object.

10. The system of claim 9 wherein the effector is selected from the group consisting of a human arm body part, a robot, and a computer.

11. A method comprising:
implanting microelectrode arrays into a cortical surface;
recording a neural data stream from the microelectrode arrays;
receiving a stream of external sensor readings;
sending the streams of recorded neural data and external sensor readings to a decoder;
processing a combined stream of the recorded neural data stream and external sensor readings stream in the decoder;
generating a command signal to an external effector from the processed combined stream.

12. The method of claim 11 wherein the stream of external sensor readings originate from a camera.

13. The method of claim 11 wherein processing comprises applying machine learning techniques.

14. The method of claim 11 wherein the effector is selected from the group consisting of a human arm body part, a robot, and a computer.

15. The method of claim 11 wherein the command signal is a command to grasp an object.
